(19) United States
(12) Patent Application Publication
(10) Pub. No.: US 2025/0371050 A1
(43) Pub. Date: Dec. 4, 2025

(54) REAL-TIME TERMINAL SERVICE GUIDANCE AND AUDITING

(71) Applicant: Cardtronics USA, Inc., Atlanta, GA (US)

(72) Inventors: Sai Teja Kasha, Dundee (GB); Gedeon Tchuiessa Kamga, Atlanta, GA (US)

(21) Appl. No.: 19/248,880

(22) Filed: Jun. 25, 2025

Related U.S. Application Data
(63) Continuation-in-part of application No. 18/675,340, filed on May 28, 2024.

(51) Int. Cl. G06F 16/3329; G06F 9/451; G06F 16/332

(52) U.S. Cl. CPC G06F 16/33295; G06F 9/453; G06F 16/3326

(57) ABSTRACT

Methods and a system for real-time auditing of service technician actions during terminal maintenance using prompt-engineered large language model analysis and interactive feedback. The technology employs prompt engineering techniques to guide a large language model in analyzing images of terminal components during service calls and comparing them against model images to determine maintenance action compliance. When non-compliant actions are detected through prompt-based analysis, detailed feedback is provided to the technician through an interactive interface using natural language generation prompts, enabling immediate correction. Real-time status updates are provided to site managers through notification prompts and comprehensive service metrics are maintained for quality assurance and performance tracking through analytical reporting prompts.

### RELATED APPLICATIONS

This application is a continuation in part of, is co-pending with, and claims priority to application Ser. No. 16/675,340 filed May 28, 2024, entitled “Technician Service Action Auditing for Compliance,” the disclosure of which is incorporated by reference in its entirety herein.

### BACKGROUND

Service technicians frequently encounter challenges when maintaining and servicing automated teller machines (ATMs) and self-service terminals, leading to unnecessary service calls and extended periods of terminal downtime. These issues often stem from poor servicing practices, high staff turnover resulting in inexperienced personnel, minimal training opportunities, and time pressures during maintenance activities. The impact is significant—in fiscal year 2023 alone, over 90,000 avoidable service actions were performed on ATM dispensers globally, resulting in multiple hours of downtime per incident and approximately $5.7 million in preventable costs. Current validation methods rely on basic image analysis that provides only binary compliance feedback, lacking the ability to guide technicians through detailed corrective actions in real-time.

### BRIEF DESCRIPTION OF THE DRAWINGS

FIG. 1 is a diagram of a system for real-time service guidance and auditing during a service call to a terminal, according to an example embodiment.

FIG. 2 is a flow diagram of a method for real-time service guidance and auditing during a service call to a terminal, according to an example embodiment.

FIG. 3 is a flow diagram of another method for real-time service guidance and auditing during a service call to a terminal, according to an example embodiment.

### DETAILED DESCRIPTION

The servicing and maintenance of automated teller machines (ATMs) and self-service terminals (SSTs) presents significant operational challenges that impact both service providers and terminal operators. These challenges manifest in various ways, including improper cash cassette loading that results in subsequent jams, failure to empty card or cash purge bins at appropriate intervals, and incorrect printer paper roll installations. Additionally, technicians sometimes struggle with balancing and settlement procedures, leading to incorrect receipt totals and reconciliation issues.

The complexity of terminal maintenance is further compounded by industry-wide challenges such as high turnover rates among service personnel, which results in a workforce that may lack comprehensive experience or thorough training. Time constraints during service visits also create pressure on technicians, particularly during cash replenishment activities where safety concerns must be balanced against tight scheduling requirements.

These operational inefficiencies have substantial financial implications. For terminal operators and maintenance service providers, the cost of avoidable service actions reached approximately $5.7 million in fiscal year 2023, with over 90,000 unnecessary service calls recorded globally for ATM dispensers alone. Each incident of poor servicing typically results in multiple hours of terminal downtime, directly impacting customer service availability and operational efficiency.

The fundamental technical challenge lies in the inability to rapidly and accurately validate service actions performed on terminal components during maintenance visits. Current validation methods are prone to errors, with accuracy rates around 60% and response times averaging 15 seconds after image capture, leading to extended terminal downtimes and increased operational costs due to repeat service visits.

A key technical limitation of existing approaches is their inability to both accurately analyze maintenance images and effectively communicate detailed guidance to technicians. Current systems can only provide basic pass/fail feedback without explaining specific discrepancies or offering step-by-step corrective instructions through natural language interaction. This communication gap between system and technician often results in incomplete repairs or repeated service visits, even when issues are initially detected.

The disclosed technology employs prompt engineering techniques to customize a large language model (LLM) for real-time analysis of maintenance actions and interactive guidance delivery. The methods and system use carefully crafted prompts to guide the LLM's behavior in analyzing terminal component images and generating specific, contextual feedback to technicians. By leveraging advanced prompt engineering methodologies including few-shot learning, chain-of-thought prompting, and role-based instructions, the technology achieves accuracy rates of 95% or higher in identifying specific differences between captured images and model references, while reducing response times to 2-3 seconds. The LLM generates detailed comparative analysis through engineered prompts and converts these findings into natural language instructions through an interactive chat interface that guides technicians to proper maintenance procedures.

The methods and system implement sophisticated prompt engineering strategies to enable the LLM to process images captured during service calls by analyzing them against model images representing correctly serviced terminal components. Unlike traditional image analysis approaches that provide only binary compliance feedback, the engineered prompts enable the LLM to identify and articulate specific discrepancies between the captured image and the model image through natural language, enabling precise identification and communication of maintenance issues to technicians in real-time.

The methods and system implement an interactive natural language chat interface that presents detailed feedback to technicians based on the LLM's prompt-engineered analysis. This real-time communication channel allows technicians to receive immediate guidance on necessary corrections while remaining at the terminal. The natural language interface enables dynamic interaction between the technician and the LLM through contextual prompt modifications, with the ability to request clarification or additional details about specific maintenance issues identified through the image analysis.

The methods and system leverage existing large-scale language model infrastructures with custom prompt engineering to ensure optimal performance scaling and load balancing. This architecture enables the LLM to maintain consistent response times of 2-3 seconds for both image analysis and natural language generation through optimized prompt structures, while achieving accuracy rates of 95% or higher in identifying and communicating specific maintenance issues. The integration with established language model infrastructure provides built-in scalability and reliability without requiring additional computational overhead.

In an embodiment, integrated cameras located inside a housing of the terminal capture images of components during service calls from multiple fixed positions. These strategically positioned cameras provide consistent baseline views of key components like the media depository and other peripherals. The integrated cameras implement a continuous streaming protocol that enables real-time analysis by the LLM through the compliance manager using engineered prompts. The LLM processes both fixed-angle images from the integrated cameras and dynamic-angle images captured by technician devices through specialized prompt configurations, correlating multiple perspectives to provide comprehensive analysis while maintaining consistent response times.

In an embodiment, integrated cameras and user device camera work in complementary roles, with the fixed cameras providing continuous monitoring of component states while the mobile camera enables technicians to capture detailed views of specific areas requiring attention. The compliance manager implements parallel processing streams for both image sources through optimized prompt engineering, enabling simultaneous analysis of multiple perspectives while maintaining the 2-3 second response time through optimized image processing pipelines.

In an embodiment, the maintenance app provides real-time guidance to technicians about optimal camera positioning based on the LLM's prompt-engineered analysis needs, ensuring that images captured through camera complement the fixed views from cameras. This coordinated multi-angle image capture enables the LLM to perform more thorough analysis of component positioning, alignment, and status indicators through specialized prompts while maintaining rapid response times through parallel processing of the image streams.

As used herein a “technician,” a “service technician,” a “customer engineer,” a “service engineer,” and/or a “user” may be used interchangeably and synonymously. This is an individual that was dispatched to a terminal to perform maintenance actions on the terminal based on an error code or a fault being raised from the terminal.

A “transaction terminal” and/or “terminal” refers to a standalone composite device operated to perform transactions for or by consumers. A terminal can include an automated teller machine (ATM), a self-service terminal (SST), a point-of-sale (POS) terminal, or a kiosk.

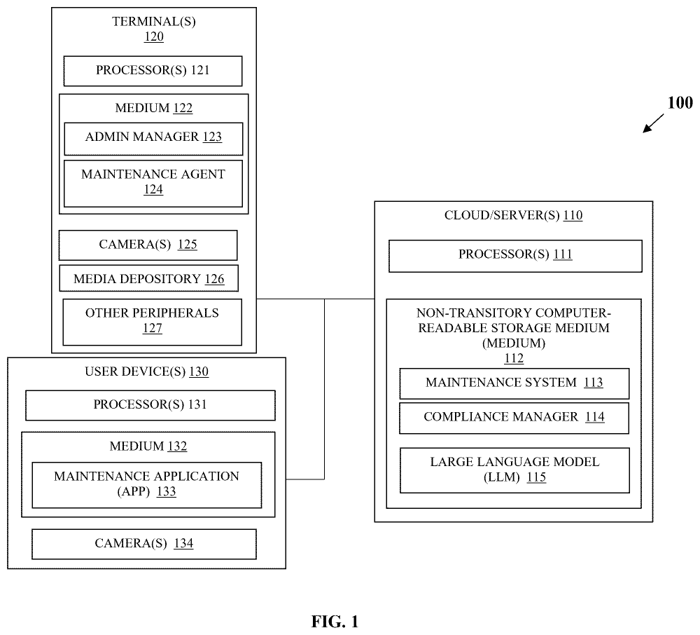

FIG. 1 is a diagram of a system 100 for real-time service guidance and auditing during a service call to a terminal, according to an example embodiment. Notably, the components are shown schematically in simplified form, with only those components relevant to understanding of the embodiments being illustrated. The system architecture integrates the LLM 115 with both the compliance manager 114 and maintenance app 133 to enable real-time image analysis and natural language interaction through prompt engineering. The architecture implements dedicated processing channels for both integrated and mobile camera streams, with the compliance manager 114 coordinating parallel analysis of multiple image sources while maintaining chat session responsiveness through optimized prompt management.

Furthermore, the various components (that are identified in system 100) are illustrated and the arrangement of the components are presented for purposes of illustration only. The components of system 100 are specifically arranged to optimize data flow between the LLM 115, maintenance app 133, and compliance manager 114, with particular attention to minimizing latency in both the image analysis and natural language processing pipelines through efficient prompt engineering. This architecture ensures that image analysis results and natural language feedback can be delivered to technicians within the target 2-3 second response time while maintaining 95% accuracy. Notably, other arrangements with more or less components are possible without departing from the teachings of real-time service guidance and auditing during a service call to a terminal, presented herein and below.

System 100 includes a cloud/server 110 (hereinafter just “cloud 110”), one or more terminals 120, and one or more user devices 130. Cloud 110 includes at least one processor 111 and a non-transitory computer-readable storage medium (hereinafter just “medium”) 112, which includes instructions for a maintenance system 113, compliance manager 114, and LLM 115. The cloud architecture implements distributed processing capabilities that allow the LLM 115 to scale horizontally across multiple processing nodes while maintaining synchronized state through the compliance manager 114 using consistent prompt engineering strategies. This distributed architecture enables parallel processing of multiple service sessions while ensuring consistent 2-3 second response times through dynamic resource allocation and load balancing. The compliance manager 114 orchestrates the interaction between LLM 115 and maintenance app 133, managing both the image analysis pipeline and natural language chat session state through dedicated processing channels that optimize prompt delivery and response handling to minimize latency.

Each terminal 120 includes at least one processor 121 and a medium 122, which includes instructions for an administration manager 123 and a maintenance agent 124. The maintenance agent 124 implements an asynchronous communication protocol with cloud 110 that enables efficient transmission of high-resolution component images while maintaining real-time chat session responsiveness. The agent interfaces with the integrated cameras 125 to capture component images and transmit them to the compliance manager 114 for LLM analysis using optimized data streaming that preserves image quality while minimizing transfer latency. The terminal 120 also includes one or more cameras 125, a media depository 126, and other peripherals 127, such as a scanner, a card reader, a weigh scale, a baggage scale, a touch display, a media depository acceptor, a media depository dispenser, a keypad, wireless transceivers, etc.

Each user device 130 includes at least one processor 131 and a medium 132, which includes instructions for a maintenance application (app) 133. The instructions when provided to and executed by processor 131 cause processor 131 to perform the processing or operations discussed herein and below with respect to 133. User device 130 further includes at least one integrated camera 134. The maintenance app 133 provides the user interface for the natural language chat session with LLM 115 and handles image capture through the integrated camera 134. The app 133 coordinates with compliance manager 114 to maintain session context and ensure proper synchronization of image analysis results with the ongoing chat interaction through prompt state management.

Initially, a processing workflow associated with detecting terminal 120 error codes or faults, scheduling service calls, and reporting terminal service call actions taken is enhanced to integrate images captured of one or more components of the terminal 120 during the service calls. The compliance manager 114 implements a parallel processing architecture that simultaneously handles image analysis through LLM 115 using engineered prompts and maintains the natural language chat session state. This dual-pipeline design enables the system to begin processing captured images through prompt-based analysis while maintaining interactive communication with the technician, contributing to the 2-3 second response time.

The maintenance system 113 sends notice of the site's location, the terminal 120, the ticket, the error code, and the scheduled service call details to a user device 130 through the maintenance app 133's user interface (UI). The compliance manager 114 coordinates the simultaneous processing of incoming images by LLM 115 through engineered prompts and the real-time chat session management. When an image is received, the compliance manager 114 immediately routes it to LLM 115 for analysis using contextual prompts while maintaining the active chat context. This parallel processing approach allows the LLM to analyze the image and generate natural language feedback within the 2-3 second target response time through optimized prompt engineering, with the compliance manager 114 ensuring proper synchronization between the analysis results and ongoing chat interaction.

Upon receipt of the information from the maintenance app 133, compliance manager 114 provides the captured image to LLM 115 for analysis using carefully crafted prompts. The LLM 115 first performs a detailed comparison between the captured image and corresponding model images through prompt-guided analysis. Unlike traditional image analysis systems, the engineered prompts enable the LLM 115 to generate a comprehensive natural language description of specific discrepancies, component positions, and maintenance issues identified. This analysis is then automatically formatted into contextual feedback suitable for real-time chat interaction with the technician through response formatting prompts.

The compliance manager 114 coordinates the dual processing streams of LLM 115, managing both the ongoing image analysis through specialized prompts and natural language chat session simultaneously. When non-compliance is determined through prompt-based analysis, the LLM 115 generates specific corrective instructions in natural language using instruction generation prompts, which compliance manager 114 delivers through the maintenance app 133's chat interface along with relevant model images. This integrated approach enables technicians to receive both visual references and detailed textual guidance within the 2-3 second response window through optimized prompt engineering.

In an embodiment, when non-compliance is detected through prompt-engineered analysis, the compliance manager 114 leverages the LLM's natural language capabilities through notification generation prompts to generate detailed status notifications for both the technician and site manager. The site manager's alert includes specific technical details about unresolved issues through specialized reporting prompts, enabling informed decisions about whether to require additional service actions before the technician leaves the site. This dual-notification approach helps prevent incomplete repairs that would require subsequent service calls.

In an embodiment, the compliance manager 114 maintains comprehensive metrics that track both the LLM's analysis accuracy and chat interaction effectiveness through prompt-based evaluation. These metrics include image analysis accuracy rates, response times for both analysis and natural language generation, chat session duration, and resolution confirmation rates. This data helps validate the LLM's consistent achievement of 95% accuracy while maintaining 2-3 second response times across both processing streams through optimized prompt engineering strategies.

In an embodiment, the compliance manager 114 integrates the LLM's analysis and chat interaction data into a comprehensive audit service through reporting prompts. This service provides detailed insights into service quality, including specific maintenance issues identified, the effectiveness of natural language guidance provided, and technician response to interactive feedback. These audit capabilities enable service providers to evaluate both technical accuracy and communication effectiveness through prompt-generated reports.

In an embodiment, the LLM 115 is also capable of generating positive feedback through the chat interface when proper maintenance actions are detected using positive reinforcement prompts. This real-time positive reinforcement helps technicians build confidence in proper procedures while maintaining engagement with the interactive guidance system throughout the service call.

The LLM 115 analyzes images and provides natural language guidance for maintenance actions across a comprehensive range of terminal components and peripherals through component-specific prompt engineering. For the media depository 126, this includes detailed analysis and feedback regarding media cassettes, cassette racks, transport modules (upper and lower), escrow and reject bins, deskew modules, media validation modules, and infeed modules through specialized prompts for each component type. The LLM 115 also provides component-specific natural language guidance for other peripherals 127 including encrypted PIN pads, card readers, various types of scales (weigh scales, baggage scales, combined scale/scanner units), scanners, receipt printers, and touchscreen interfaces through tailored prompt configurations. For each component, the LLM identifies specific discrepancies from proper servicing procedures and communicates corrective actions through the interactive chat interface using contextual prompts, enabling real-time guidance while the technician remains at the terminal.

In an embodiment, the LLM 115 maintains context awareness throughout the chat session by tracking previously identified issues and provided guidance through conversation state prompts. This enables the LLM to reference earlier maintenance actions and build upon previous instructions when analyzing new images through contextual prompt engineering, providing more cohesive and effective guidance to technicians.

In an embodiment, the LLM's training process is achieved through prompt engineering and involves iterative refinement using a comprehensive database of model terminal component images. The training dataset includes thousands of image pairs showing both correct and incorrect maintenance states, with each pair annotated with detailed natural language descriptions of the specific differences. This paired image-text training enables the LLM to achieve 95% accuracy by learning to identify subtle variations in component positioning, alignment, and status indicators while simultaneously developing the ability to articulate these differences in clear, actionable language. The training process specifically focuses on common maintenance scenarios identified through historical service records, ensuring the LLM 115 can accurately detect and communicate about the most frequently encountered issues.

In an embodiment, the LLM's high accuracy rate is further enabled by its specialized training on terminal-specific components and maintenance procedures. During training and using prompt engineering, the LLM 115 learns to recognize standardized maintenance patterns across different terminal types while developing contextual understanding of how various components should appear when properly serviced. This domain-specific training, combined with the parallel processing architecture implemented by compliance manager 114, enables the LLM 115 to maintain its 95% accuracy rate even while processing multiple service calls simultaneously. The training process incorporates feedback loops that continuously refine the model's ability to both detect maintenance issues and generate clear, precise natural language instructions for resolving them.

The system 100 employs sophisticated prompt engineering techniques including few-shot learning, where example maintenance scenarios are provided within prompts to guide the LLM's analysis patterns. Chain-of-thought prompting is used to ensure the LLM reasons step-by-step through maintenance validation processes, while role-based prompts establish the LLM as a technical maintenance expert. Formatting constraints within prompts ensure consistent output structure for both analysis results and guidance instructions, enabling reliable integration with the maintenance app 133's user interface.

The prompt engineering methodology includes explicit instructions that clearly define the LLM's analysis tasks, such as “Compare the captured image against the model image and identify specific discrepancies in component positioning, alignment, and status indicators.” Few-shot learning prompts provide examples of proper analysis patterns, while chain-of-thought prompts guide the LLM to explain its reasoning process when identifying maintenance issues. Role-based prompts establish context such as “You are an expert terminal maintenance technician analyzing component images for compliance,” ensuring appropriate technical depth and communication style.

The compliance manager 114 implements dynamic prompt adaptation that modifies prompt structures based on terminal type, component being serviced, and technician experience level. This adaptive prompting ensures that the LLM's responses are appropriately tailored to the specific maintenance context while maintaining consistent accuracy and response times. The system 100 maintains a library of prompt templates optimized for different maintenance scenarios, enabling rapid customization without compromising performance.

In an embodiment, the compliance manager 114 maintains a historical record of chat interactions and image analyses for each terminal 120 through conversation logging prompts. This historical data enables the LLM 115 to identify patterns in maintenance issues and adjust its guidance accordingly through pattern recognition prompts, while also providing valuable insights for improving service procedures and technician training through analytical reporting prompts.

In an embodiment, the media depository 126 is a media recycler. In an embodiment, the media depository is a cash and/or currency dispenser. In an embodiment, the media depository is a combined cash depositor and dispenser.

In an embodiment, an Internet-of-Things (IoTs) camera or cameras are placed within a housing of the terminal 120 at predefined locations optimized for monitoring specific components. The cameras wirelessly transmit images of components during service sessions between a service technician and maintenance system 113 and/or LLM 115. The IoTs cameras complement the images captured through maintenance app 133 by providing consistent baseline views that enable the LLM 115 to track maintenance progress through its prompt-engineered image analysis and natural language processing capabilities.

In an embodiment, the maintenance system 113 and/or LLM 115 can distinguish between IoTs cameras based on camera identifiers being mapped or linked to specific components of the terminal 120 through identification prompts. The IoTs cameras provide continuous monitoring of component states during service sessions, enabling real-time validation of maintenance actions through the LLM 115's prompt-engineered analysis and natural language feedback capabilities.

In an embodiment, an IoTs camera is situated within each media cassette in a top corner on a lid that covers a top of the cassette. When the technician shuts the lid after replenishing media, the camera sends a real-time image to LLM 115, which analyzes the image using media validation prompts and provides immediate natural language feedback about the loaded media's alignment and positioning through the maintenance app 133's chat interface.

In an embodiment, the compliance manager 114 implements sophisticated caching mechanisms that optimize performance by maintaining frequently accessed model images and component state information in high-speed memory. This caching system, combined with the parallel processing architecture, enables the LLM 115 to begin analysis immediately upon image receipt while maintaining chat session responsiveness.

In an embodiment, the compliance manager 114 coordinates component-specific processing pipelines that are optimized for different terminal peripherals. Each pipeline implements specialized pre-processing steps and validation rules while maintaining consistent interfaces with the LLM 115. This modular architecture enables efficient handling of diverse maintenance scenarios while ensuring consistent performance across all terminal components.

In an embodiment, the maintenance app 133 implements an optimized client-side architecture that enables real-time image capture and chat interaction while minimizing network latency. The maintenance app 133 maintains a local processing queue that handles image compression and preliminary validation before transmission, ensuring efficient use of network bandwidth while preserving image quality necessary for LLM analysis.

In an embodiment, the maintenance app 133 implements a sophisticated state management system that maintains synchronization with both the LLM 115 and compliance manager 114. This architecture enables the maintenance app 133 to continue providing interactive feedback even during image processing operations. The app 133 employs WebSocket connections for chat interactions while using separate optimized channels for image transmission, ensuring responsive user interaction while maintaining the 2-3 second end-to-end response time.

In an embodiment, the maintenance app 133 implements an adaptive interface that dynamically adjusts based on terminal type and component being serviced. When capturing images, the interface provides real-time guidance about optimal camera positioning and lighting conditions based on the specific component requirements. This guidance is continuously updated based on feedback from the LLM 115, ensuring captured images meet quality standards for accurate analysis.

In an embodiment, the maintenance app 133 maintains a local cache of component diagrams and model images that enables immediate visual feedback to technicians while awaiting detailed analysis from the LLM 115. This hybrid approach combines local processing with cloud-based analysis to provide continuous guidance throughout the service call. The app implements sophisticated cache management that ensures relevant reference materials are available offline while maintaining synchronization with the cloud-based model image database.

The above-described components and their arrangements provide the architectural foundation that enables real-time service guidance and auditing during terminal maintenance through advanced prompt engineering. The LLM 115's prompt-engineered image analysis and natural language capabilities, combined with the compliance manager 114's sophisticated coordination and the maintenance app 133's optimized interfaces, work together to achieve the target 2-3 second response times with 95% accuracy. This technical implementation addresses the fundamental challenges of rapidly validating maintenance actions while providing clear, actionable guidance to technicians through natural language interaction enabled by sophisticated prompt engineering techniques.

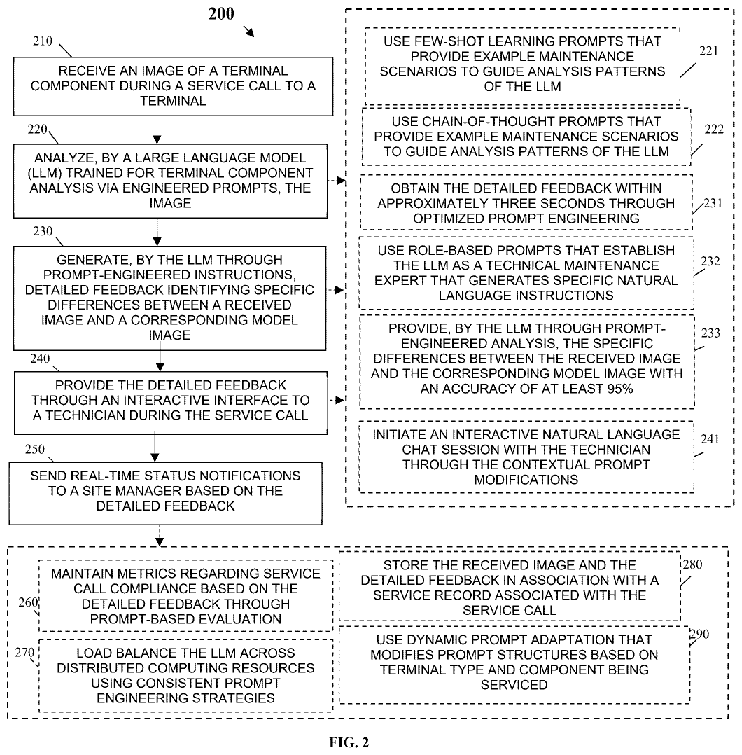

FIG. 2 is a flow diagram of a method 200 for real-time service guidance and auditing during a service call to a terminal, according to an example embodiment. The software module(s) that implements the method 200 is referred to as a “maintenance guidance manager.” The maintenance guidance manager is implemented as executable instructions programmed and residing within memory and/or a non-transitory computer-readable (processor-readable) storage medium and executed by one or more processors of one or more devices. The processor(s) of the device(s) that executes the maintenance guidance manager are specifically configured and programmed to process the maintenance guidance manager. The maintenance guidance manager may have access to one or more network connections during its processing. The network connections can be wired, wireless, or a combination of wired and wireless.

In an embodiment, the device that executes the maintenance guidance manager is cloud 110 or a server. In an embodiment, the devices that execute the maintenance guidance manager are cloud 110 and terminal 120. In an embodiment, the devices that execute the maintenance guidance manager are cloud 110 and user device 130. In an embodiment, the maintenance guidance manager is any combination of or all of maintenance system 113, compliance manager, LLM 115, maintenance agent 124, and/or maintenance app 133.

At 210, the maintenance guidance manager receives an image of a terminal component during a service call to a terminal 120. At 220, the maintenance guidance manager analyzes, by a LLM 115 trained for terminal component analysis via engineered prompts, the image. In an embodiment, at 221, maintenance guidance manager uses few-shot learning prompts that provide example maintenance scenarios to guide analysis patterns of the LLM 115. In an embodiment, at 222, the maintenance guidance manager uses chain-of-thought prompts that provide example maintenance scenarios to guide analysis patterns of the LLM 115.

At 230, the LLM 115 generates, through prompt-engineered instructions, detailed feedback that identifies specific differences between a received image and a corresponding model image. In an embodiment, at 231, the maintenance guidance manager obtains the detailed feedback within approximately three seconds through optimized prompt engineering. In an embodiment, at 232, the maintenance guidance manager uses role-based prompts that establish the LLM 115 as a technical maintenance expert that generates specific natural language instructions. In an embodiment, at 233, the LLM 115 provides, through prompt-engineered analysis, the specific differences between the received image and the corresponding model image with an accuracy of at least approximately 95%.

At 240, the maintenance guidance manager provides the detailed feedback through an interactive interface, such as app 133, to a technician during the service call. In an embodiment, at 241, the maintenance guidance manager initiates an interactive natural language chat session with the technician through contextual prompt modifications. In an embodiment, the chat session is initiated without any additional input beyond receipt of the received image being required of the technician through the interactive interface of app 133.

At 250, the maintenance guidance manager sends real-time status notifications to a site manager based on the detailed feedback. In an embodiment, at 260, the maintenance guidance manager maintains metrics regarding service call compliance based on the detailed feedback through prompt-based evaluation.

In an embodiment, at 270, the maintenance guidance manager load balances the LLM 115 across distributed computing resources using consistent prompt engineering strategies. In an embodiment, at 280, the maintenance guidance manager stores the received image and the detailed feedback in association with a service record associated with the service call. In an embodiment, at 290, the maintenance guidance manager uses dynamic prompt adaptation based on a terminal type and a component being serviced.

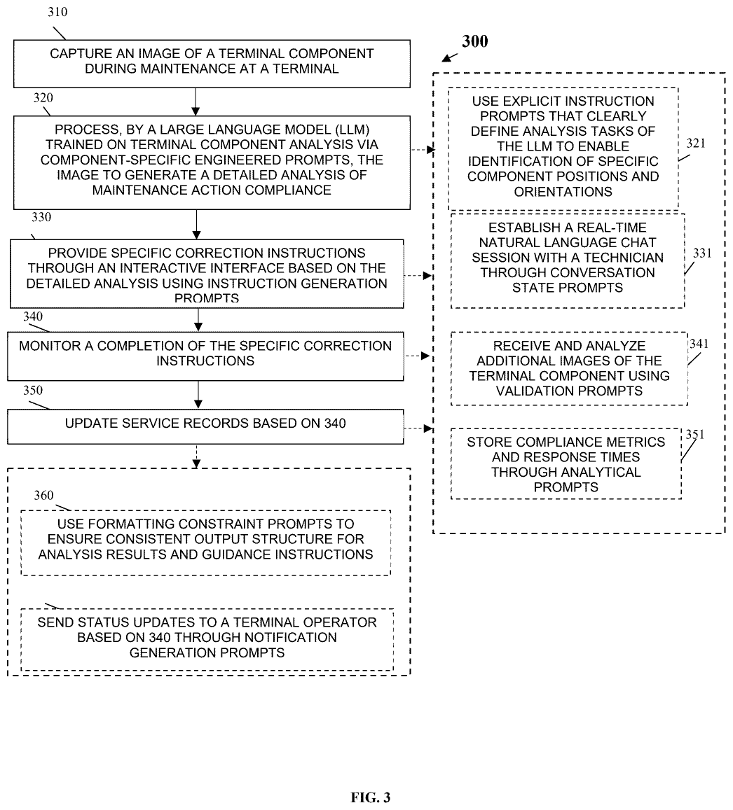

FIG. 3 is a flow diagram of another method 300 for real-time service guidance and auditing during a service call to a terminal, according to an example embodiment. The software module(s) that implements the method 300 is referred to as a “natural language maintenance assistance manager.” The natural language maintenance assistance manager is implemented as executable instructions programmed and residing within memory and/or a non-transitory computer-readable (processor-readable) storage medium and executed by one or more processors of one or more device(s). The processors that execute the natural language maintenance assistance manager are specifically configured and programmed for processing the natural language maintenance assistance manager. The natural language maintenance assistance manager may have access to one or more network connections during its processing. The network connections can be wired, wireless, or a combination of wired and wireless.

In an embodiment, the device that natural language maintenance assistance manager is cloud 110 or a server. In an embodiment, the devices that execute the natural language maintenance assistance manager are cloud 110 and terminal 120. In an embodiment, the devices that execute the natural language maintenance assistance manager are cloud 110 and user device 130. In an embodiment, the natural language maintenance assistance manager is any combination of or all of maintenance system 113, compliance manager 114, LLM 115, maintenance agent 124, maintenance app 133, and/or method 200. The natural language maintenance assistance manager presents another and, in some ways, enhanced processing perspective from that which was discussed above for the system 100 of FIG. 1 and method 200 of FIG. 2.

At 310, the natural language maintenance assistance manager captures an image of a terminal component during maintenance at a terminal 120. At 320, a LLM 115, which is trained on terminal component analysis via component-specific engineered prompts, processes the image to generate a detailed analysis of maintenance action compliance. In an embodiment, at 321, the natural language maintenance assistance manager uses explicit instruction prompts that clearly define analysis tasks of the LLM 115 to enable identification of specific component positions and orientations.

At 330, the LLM 115 provides specific correction instructions through an interactive interface, such as app 133, based on the detailed analysis using instruction generation prompts. In an embodiment, at 331, the LLM 115 establishes a real-time natural language chat session with a technician through conversation state prompts. The technician is operating a mobile device, such as user device 130. In an embodiment, the mobile device is initially operated by the technician to capture and provide the image.

At 340, the natural language maintenance assistance manager monitors for a completion of the specific correction instructions. In an embodiment, at 341, the LLM 115 receives and analyzes additional images captured and supplied for the terminal component using validation prompts to ensure the specific correction instructions were performed by the technician.

At 350, the natural language maintenance assistance manager updates service records based on 340. In an embodiment, at 351, the natural language maintenance assistance manager stores compliance metrics and response times through analytical prompts for the maintenance and performance of the correction instructions by the technician.

In an embodiment, at 360, the natural language maintenance assistance manager uses formatting constraint prompts to ensure consistent output structure for analysis results and guidance instructions. In an embodiment, at 370, the natural language maintenance assistance manager sends status updates to a terminal operator (e.g., technician, site manager, etc.) based on 340 through notification generation prompts.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving an image of a terminal component during a service call to a terminal;
analyzing, by a large language model (LLM) trained for terminal component analysis via engineered prompts, the image;
generating, by the LLM through prompt-engineered instructions, detailed feedback identifying specific differences between a received image and a corresponding model image;
providing the detailed feedback through an interactive interface to a technician during the service call; and
sending real-time status notifications to a site manager based on the detailed feedback.

2. The method of claim 1, wherein analyzing the image comprises using few-shot learning prompts that provide example maintenance scenarios to guide analysis patterns of the LLM.

3. The method of claim 1, wherein analyzing the image comprises using chain-of-thought prompts that guide the LLM to reason step-by-step through maintenance validation processes.

4. The method of claim 1, wherein generating the detailed feedback comprises obtaining the detailed feedback within approximately three seconds through optimized prompt engineering.

5. The method of claim 1, wherein generating the detailed feedback comprises using role-based prompts that establish the LLM as a technical maintenance expert that generates specific natural language instructions.

6. The method of claim 1, wherein generating further includes providing, by the LLM through prompt-engineered analysis, the specific differences between the received image and the corresponding model image with an accuracy of at least 95%.

7. The method of claim 1, wherein providing the detailed feedback comprises initiating an interactive natural language chat session with the technician through contextual prompt modifications.

8. The method of claim 1, further comprising maintaining metrics regarding service call compliance based on the detailed feedback through prompt-based evaluation.

9. The method of claim 1, further comprising load balancing the LLM across distributed computing resources using consistent prompt engineering strategies.

10. The method of claim 1, further comprising storing the received image and the detailed feedback in association with a service record associated with the service call.

11. The method of claim 1, further comprising using dynamic prompt adaptation that modifies prompt structures based on terminal type and component being serviced.

12. A method, comprising:
capturing an image of a terminal component during maintenance at a terminal;
processing, by a large language model (LLM) trained on terminal component analysis via component-specific engineered prompts, the image to generate a detailed analysis of maintenance action compliance;
providing specific correction instructions through an interactive interface based on the detailed analysis using instruction generation prompts;
monitoring a completion of the specific correction instructions; and
updating service records based on the monitoring.

13. The method of claim 12, wherein processing the image comprises using explicit instruction prompts that clearly define analysis tasks of the LLM to enable identification of specific component positions and orientations.

14. The method of claim 12, wherein providing the specific correction instructions comprises establishing a real-time natural language chat session with a technician through conversation state prompts.

15. The method of claim 12, wherein monitoring the completion comprises receiving and analyzing additional images of the terminal component using validation prompts.

16. The method of claim 12, wherein updating the service records comprises storing compliance metrics and response times through analytical reporting prompts.

17. The method of claim 12, further comprising using formatting constraint prompts to ensure consistent output structure for analysis results and guidance instructions.

18. The method of claim 12, further comprising sending status updates to a terminal operator based on the monitoring through notification generation prompts.

19. A system, comprising:
at least one processor; and
instructions that when executed by the at least one processor cause the at least one processor to perform operations, comprising:
receiving images of terminal components during service calls;
analyzing, by a large language model (LLM) trained to identify maintenance compliance via engineered prompts, the images by comparing received images against model images;
generating detailed feedback specifying differences between the received images and corresponding model images through prompt-engineered instructions;
providing the detailed feedback through an interactive interface using contextual prompt modifications; and
maintaining service quality metrics based on the detailed feedback through prompt-based evaluation.

20. The system of claim 19, wherein the LLM achieves at least 95% accuracy in analyzing the received images and in generating the detailed feedback within 3 seconds through optimized prompt engineering strategies.
